(19) United States
(12) Patent Application Publication
(10) Pub. No.: US 2009/0109591 A1
(43) Pub. Date: Apr. 30, 2009

(54) INRUSH CURRENT PROTECTION CIRCUIT

(75) Inventors: Chia-Hsiang Li, Taoyuan Hsien (TW); Houng-Liang Chen, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/924,846

(22) Filed: Oct. 26, 2007

(51) Int. Cl. H02H 5/04

(52) U.S. Cl. 361/104

(57) ABSTRACT

Disclosed is an inrush current protection circuit for preventing inrush energy from entering a circuit to be protected through a power input terminal of the circuit to be protected. The inrush current protection circuit includes a varistor connected to the power input terminal of the circuit to be protected for absorbing inrush energy, and a thermal fuse having one end connected with the varistor and the power input terminal of the circuit to be protected and having the other end connected to a power line, in which when the thermal fuse is blown out, the circuit to be protected is disconnected from the power line.

### FIELD OF THE INVENTION

The present invention is related to a protection circuit, and more particularly to an inrush current protection circuit.

### BACKGROUND OF THE INVENTION

With the rapid progress of information technology and the rapid development of the high-tech industry, most of the sophisticated electronic instruments and equipment rely on high-quality power supply to maintain a normal operation. If the voltage of the power supply is too high, the internal circuits of the sophisticated electronic instruments and equipment will be damaged. Therefore, it is an important task to efficiently protect the internal circuits of an electronic device when an over-voltage condition occurs.

Referring to FIG. 1, the circuitry of a conventional inrush current protection circuit is shown. As shown in FIG. 1, the inrush current protection circuit 1 includes a thermal fuse 11 and a metal oxide varistor 12, in which the thermal fuse 11 is connected in series with the metal oxide varistor 12 and connected in parallel with a line fuse 21. The line fuse 21 and the thermal fuse 11 are connected to the power input terminal of the circuit to be protected 22. Power is supplied from the hot line L and the neutral line N to the circuit to be protected 22 through the line fuse 21 and the inrush current protection circuit 1. When inrush current occurs, the energy of the inrush current will be conveyed to the metal oxide varistor 12 through the line fuse 21 and the thermal fuse 11. Therefore, the power input terminal of the circuit to be protected 22 will not undergo over-voltage condition. Besides, if the instantaneous inrush current is too high, the current flowing through the line fuse 21 will increase and exceed the rated tolerable current of the line fuse 21, thereby blowing out the line fuse 21. Under this condition, the circuitry will be cut off before the energy absorbed by the metal oxide varistor 12 exceeds the energy absorbable by the metal oxide varistor 12, thereby preventing the metal oxide varistor 12 from burning down and affecting the normal operation of the circuit to be protected 22. Nonetheless, when the inrush current is low and continues to flow, the current flowing through the line fuse 21 will not exceed the rated tolerable current of the line fuse 21, and the metal oxide varistor 12 will be heated by absorbing the energy of the inrush current. Therefore, the temperature of the metal oxide varistor 12 will increase. When the temperature of the metal oxide varistor 12 exceeds the rated temperature of the thermal fuse 11, the thermal fuse 11 will blow out to prevent the temperature of the metal oxide varistor 12 from increasing and inhibit the circuitry from burning down. However, the blowout of the thermal fuse 11 will cut off the connection between the metal oxide varistor 12 and the power input terminal of the circuit to be protected 22. When the inrush current recurs, the energy of the inrush current will be conveyed to the circuit to be protected 22 through the power input terminal of the circuit to be protected 22, thereby burning down the circuit to be protected 22.

Referring to FIG. 2, the circuitry of another conventional inrush current protection circuit is shown. As shown in FIG. 2, the inrush current protection circuit 1a includes a thermal fuse 11 and a metal oxide varistor 12. In addition, the inrush current protection circuit 1a includes a surveillance circuit 13 that is connected with the thermal fuse 11 and the metal oxide varistor 12 through a monitor lead 11a. The surveillance circuit 13 includes a diode 131, a LED 132, and a resistor 133 connected in series with each other between the monitor lead 11a and the neutral line N. Power is supplied from the hot line L and the neutral line N to the circuit to be protected 22 through the line fuse 21 and the inrush current protection circuit 1a. In normal operation, the surveillance circuit 13 will form a loop with the line fuse 21 and the thermal fuse 11 and induce current, so that the LED 132 of the surveillance circuit 13 can be lightened up. When the inrush current is low and continues to flow, the current flowing through the line fuse 21 will not exceed the rated tolerable current of the line fuse 21, and the metal oxide varistor 12 will be heated by absorbing the energy of the inrush current. Therefore, the temperature of the metal oxide varistor 12 will increase. When the temperature of the metal oxide varistor 12 exceeds the rated temperature of the thermal fuse 11, the thermal fuse 11 will blow out to prevent the temperature of the metal oxide varistor 12 from increasing and inhibit the circuitry from burning down. However, the blowout of the thermal fuse 11 will cut off the loop formed by the surveillance circuit 13, the line fuse 21 and the thermal fuse 11. Therefore, the LED 132 of the surveillance circuit 13 will be put out. In the meantime, the user can know that the inrush current protection circuit 1a has been disconnected from the circuit to be protected 22 and can not inhibit the inrush current from entering the circuit to be protected 22. Under this condition, the user has to replace the thermal fuse 11 or cut off the power supply to inhibit the inrush current from entering the circuit to be protected 22.

As stated above, the conventional inrush current protection circuit bears a disadvantage that the connection between the inrush current protection and the circuit to be protected will be cut off when the internal thermal fuse is blown out. Under this condition, the circuit to be protected is still connected with the power line that is interfered with inrush current, so that the inrush current can enter the circuit to be protected and burn down the circuit to be protected accordingly. Hence, it is an urgent task to develop an inrush current protection circuit to remove the aforementioned drawback encountered by the prior art.

### SUMMARY OF THE INVENTION

An object of the present invention is to provide an inrush current protection circuit for preventing inrush energy from entering the circuit to be protected through the power input terminal of the circuit to be protected. The principle of the invention is to allow the inrush current protection circuit and the circuit to be protected to be disconnected from power line when the internal thermal fuse of the inrush current protection circuit is blown out. In this way, the inrush energy can not enter the circuit to be protected through the power input terminal of the circuit to be protected, so that the aforementioned drawback can be removed.

To this end, an aspect of the present invention provides an inrush current protection circuit for preventing inrush energy from entering the circuit to be protected through the power input terminal of the circuit to be protected. The inrush current protection circuit includes a varistor connected to the power input terminal of the circuit to be protected for absorbing inrush energy, and a thermal fuse having one end connected with the varistor and the power input terminal of the circuit to be protected and having the other end connected to a power line. When the thermal fuse is blown out, the circuit to be protected is disconnected from the power line.

Another aspect of the present invention provides an inrush current protection circuit for preventing inrush energy from entering the circuit to be protected through the power input terminal of the circuit to be protected. The inrush current protection circuit includes a line fuse connected in series with a power line, and an inrush current protection device having a first conducting terminal, a second conducting terminal, and a third conducting terminal, in which the first conducting terminal is connected to the line fuse, the second conducting terminal is connected to the power line, and the third conducting terminal is connected to the power input terminal of the circuit to be protected. The inrush current protection device further includes a varistor connected with the second conducting terminal and the third conducting terminal for absorbing inrush energy, and a thermal fuse connected with the first conducting terminal and the third conducting terminal, in which the circuit to be protected is disconnected from the power line when the thermal fuse is blown out.

Now the foregoing and other features and advantages of the present invention will be best understood through the following descriptions with reference to the accompanying drawings, wherein:

### BRIEF DESCRIPTION OF THE DRAWINGS

FIG. 1 is a circuit diagram showing a conventional inrush current protection circuit;

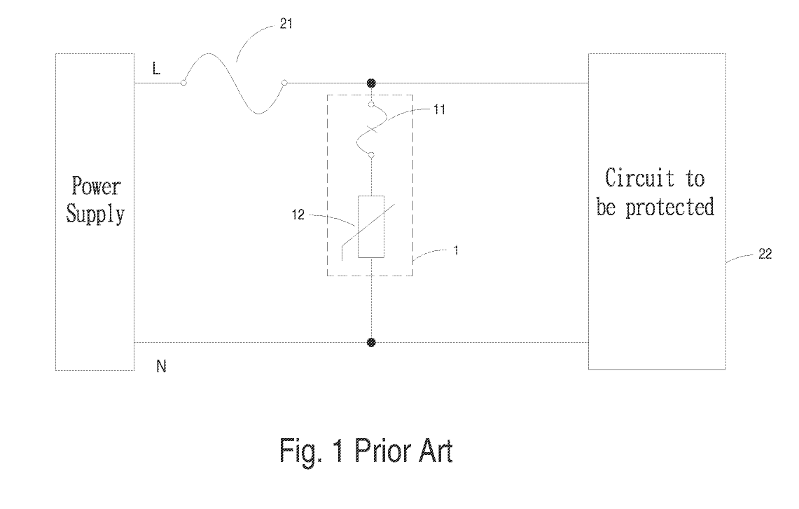

FIG. 2 is a circuit diagram showing another conventional inrush current protection circuit; and

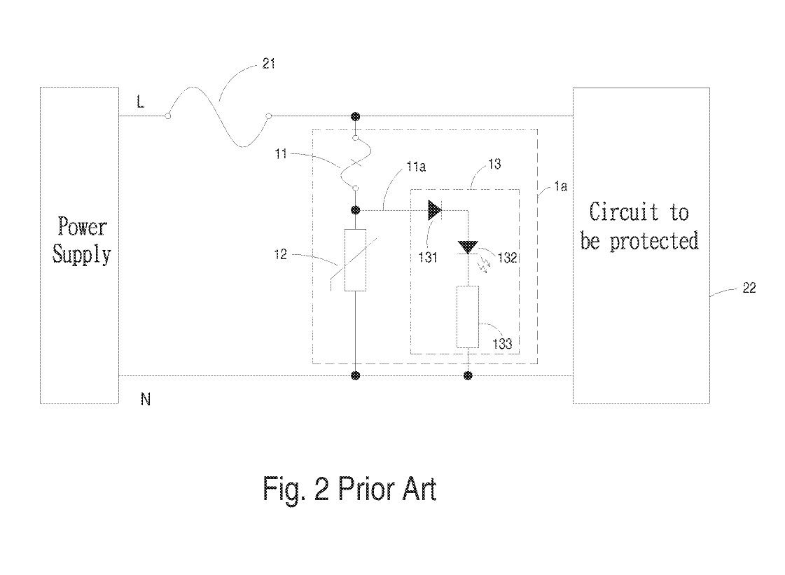

FIG. 3 is a circuit diagram showing an inrush current protection circuit according to a preferred embodiment of the present invention.

### DETAILED DESCRIPTION OF THE PREFERRED EMBODIMENT

A preferred embodiment embodying the features and advantages of the present invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

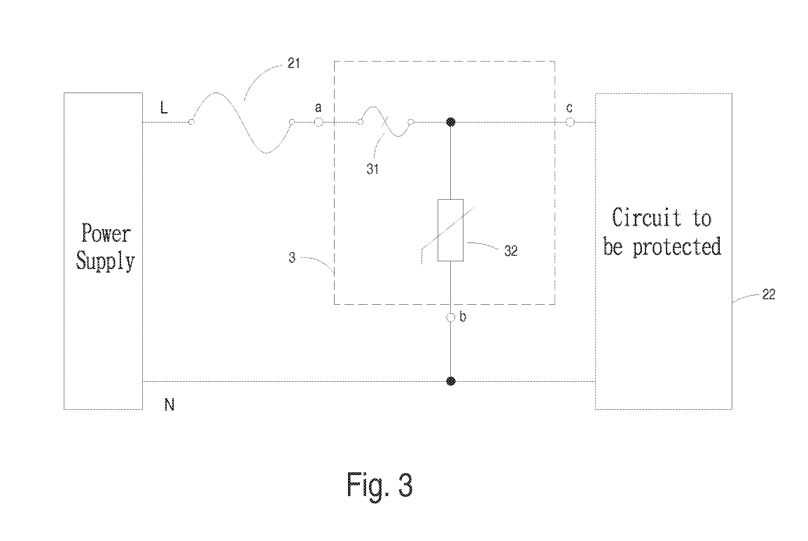

Referring to FIG. 3, the circuitry of an inrush current protection circuit according to a preferred embodiment of the present invention is shown. In FIG. 3, the inventive inrush current protection circuit 3 includes a thermal fuse 31 and a varistor 32 such as a metal oxide varistor, in which one end of the thermal fuse 31 is connected to a line fuse 21 and the other end of the thermal fuse 31 is connected with the varistor 32 and the power input terminal of the circuit to be protected 22. The varistor 32 is connected in parallel with the power input terminal of the circuit to be protected 22. In the present embodiment, power is supplied from the hot line L and the neutral line N to the circuit to be protected 22 through the line fuse 21 and the inrush current protection circuit 3. When inrush current occurs, the inrush energy will be conveyed to the varistor 32 through the line fuse 21 and the thermal fuse 31. Therefore, the power input terminal of the circuit to be protected 22 will not undergo over-voltage condition. Besides, if the instantaneous inrush current is too high, the current flowing through the line fuse 21 will increase and exceed the rated tolerable current of the line fuse 21, thereby blowing out the fuse 21. Under this condition, the circuitry will be cut off before the energy absorbed by the varistor 32 exceeds the energy absorbable by the varistor 32, thereby preventing the varistor 32 from burning down and affecting the normal operation of the circuit to be protected 22.

When the inrush current is low and continues to flow, the current flowing through the line fuse 21 will not exceed the rated tolerable current of the line fuse 21, and the varistor 32 will be heated by absorbing the energy of the inrush current. Therefore, the temperature of the varistor 32 will increase. When the temperature of the varistor 32 exceeds the rated temperature of the thermal fuse 31, for example, 200° C., the thermal fuse 31 will blow out to prevent the temperature of the varistor 32 from increasing and inhibit the circuitry from burning down. Because the thermal fuse 31 is connected in series with the power input terminal of the circuit to be protected 22, the circuit to be protected 22 can be disconnected from the power line when the thermal fuse 31 is blown out, so that the inrush energy can not enter the circuit to be protected 22 through the power input terminal of the circuit to be protected 22.

In addition, it should be noted that the thermal fuse 31 is adjacent to the varistor 32. When the varistor 32 absorbs inrush energy and undergo temperature variation, the thermal fuse 31 can sense the temperature variation of the varistor 32 immediately. Hence, a preferred arrangement of the thermal fuse 31 and the varistor 32 is to place the thermal fuse 31 and the varistor 32 together and allow the thermal fuse 31 and the varistor 32 to be contacted with each other. Nonetheless, increasing the contact area of the thermal fuse 31 and the varistor 32 can enhance the ability of the thermal fuse 31 to sense the temperature variation of the varistor 32. In the present embodiment, the thermal fuse 31 and the varistor 32 can be packaged into a solitary element, thereby simplifying the manufacturing process of the inrush current protection circuit 3 and increasing the circuit density of the inrush current protection circuit 3.

In the present embodiment, the circuit to be protected 22 can be, but not limited to, an uninterruptible power supply. In addition, the cause of inrush current can be, but not limited to, thunderbolt. FIG. 3 illustrates another embodiment of the present invention. In FIG. 3, the inrush current protection circuit 3 can be packaged to a solitary element or an inrush current protection device having a first conducting terminal a, a second conducting terminal b, and a third conducting terminal c. In this embodiment, the first conducting terminal a is connected to the line fuse 21, the second conducting terminal b is connected to the neutral line N, and the third conducting terminal c is connected to the power input terminal of the circuit to be protected 22. The varistor 32 is connected with the second conducting terminal b and the third conducting terminal c for absorbing inrush energy, and the thermal fuse 31 is connected with the first conducting terminal a and the third conducting terminal c.

In conclusion, the inventive inrush current protection circuit can prevent inrush energy from entering the circuit to be protected through the power input terminal of the circuit to be protected. When the thermal fuse of the inrush current protection circuit is blown out, the inrush current protection circuit and the circuit to be protected will be disconnected from the power line. Therefore, inrush energy can not enter the circuit to be protected through the power input terminal of the circuit to be protected. Hence, the present invention can remove the drawback that inrush energy enters the circuit to be protected when the thermal fuse of the inrush current protection circuit is blown out. Furthermore, the inventive inrush current protection circuit can employ a solitary element incorporating a thermal fuse and a varistor to simplify the circuitry of the inrush current protection circuit and increase the circuit density of the inrush current protection circuit.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. An inrush current protection circuit for preventing an inrush energy from entering a circuit to be protected through a power input terminal of the circuit to be protected, the inrush current protection circuit comprising:
a varistor connected to the power input terminal of the circuit to be protected for absorbing the inrush energy; and
a thermal fuse having one end connected with the varistor and the power input terminal of the circuit to be protected and having the other end connected to a power line;
wherein when the thermal fuse is blown out, the circuit to be protected is disconnected from the power line.

2. The inrush current protection circuit according to claim 1 further comprising a line fuse connected in series between the power line and the thermal fuse.

3. The inrush current protection circuit according to claim 2 wherein the power line includes a hot line and a neutral line.

4. The inrush current protection circuit according to claim 3 wherein the line fuse is connected to the hot line.

5. The inrush current protection circuit according to claim 3 wherein one end of the varistor is connected to the neutral line.

6. The inrush current protection circuit according to claim 1 wherein the thermal fuse is connected in series with the power input terminal of the circuit to be protected.

7. The inrush current protection circuit according to claim 1 wherein the varistor is connected in parallel with the power input terminal of the circuit to be protected.

8. The inrush current protection circuit according to claim 1 wherein the varistor is a metal oxide varistor.

9. The inrush current protection circuit according to claim 1 wherein the thermal fuse has a rated temperature.

10. The inrush current protection circuit according to claim 1 wherein the thermal fuse and the varistor are packaged into a solitary element.

11. The inrush current protection circuit according to claim 10 wherein the solitary element has three conducting terminals.

12. An inrush current protection circuit for preventing an inrush energy from entering a circuit to be protected through a power input terminal of the circuit to be protected, the inrush current protection circuit comprising:
a line fuse connected in series with a power line; and
an inrush current protection device having a first conducting terminal, a second conducting terminal, and a third conducting terminal, wherein the first conducting terminal is connected to the line fuse, the second conducting terminal is connected to the power line, and the third conducting terminal is connected to the power input terminal of the circuit to be protected, the inrush current protection device comprising:
a varistor connected to the second conducting terminal and the third conducting terminal for absorbing the inrush energy; and
a thermal fuse connected to the first conducting terminal and the third conducting terminal;
wherein when the thermal fuse is blown out, the circuit to be protected is disconnected from the power line.

13. The inrush current protection circuit according to claim 12 wherein the varistor is a metal oxide varistor.

14. The inrush current protection circuit according to claim 12 wherein the thermal fuse has a rated temperature.

15. The inrush current protection circuit according to claim 12 wherein the power line includes a hot line and a neutral line.

16. The inrush current protection circuit according to claim 15 wherein the line fuse is connected to the hot line.

17. The inrush current protection circuit according to claim 15 wherein the second conducting terminal of the inrush current protection device is connected to the neutral line.

18. The inrush current protection circuit according to claim 12 wherein the inrush current protection device is a solitary element.
